(19) United States
(12) Patent Application Publication
(10) Pub. No.: US 2002/0113503 A1
(43) Pub. Date: Aug. 22, 2002

(54) Spindle motor

(75) Inventor: Osamu Nagatsuka, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/077,810

(22) Filed: Feb. 20, 2002

(30) Foreign Application Priority Data
Feb. 21, 2001 (JP) 2001-044414

(51) Int. Cl. H02K 7/00; H02K 11/00

(52) U.S. Cl. 310/67 R

(57) ABSTRACT

There is provided a spindle motor that has a thin rotor and a thin turntable and is therefore suitable for use in thin optical disk apparatuses. The spindle motor is comprised of a stator, and a rotor in which a rotary shaft support member is secured to the rotary shaft. A rotary table member is disposed for rotation in unison with the rotary shaft support member, and has mounted thereon a recording medium with a clamping plate having a central hole. The rotary shaft and the rotary shaft support member are inserted into the central hole in the clamping plate for the recording medium.

### BACKGROUND OF THE INVENTION

1. Field of the Invention

The present invention relates to a spindle motor that is usable for rotatively driving recording media, such as an optical disk (for example, mini disk (MD) or compact disk (CD)), a magneto-optical disk, and a magnetic disk, to play back or record information through rotation thereof.

2. Description of the Related Art

A conventional spindle motor in an optical disk apparatus has a configuration such as that shown in FIG. 3. In FIG. 3, a spindle motor 30 is comprised of a stator 31 that is fixedly mounted in an optical disk apparatus (not shown), and a rotor 32 that is supported by the stator 31 for rotation relative to the stator 31.

The stator 31 is comprised of a stator base 33, a housing 34 attached to the stator base 33, a winding 35 disposed around the housing 34, and a plain bearing 36 fitted in the housing 34 by press fitting or the like.

The rotor 32 is comprised of a rotary shaft 37 rotatably supported by the plain bearing 36, a cylindrical rotor yoke 38 having an open lower end, secured to the rotary shaft 37 and disposed in a fashion surrounding the winding 35 in the radial direction, a rotor magnet 39 that is fixedly mounted inside the rotor yoke 38, a turntable 40 attached to a top end of the rotary shaft 37, a clamping magnet 41 provided on the turntable 40, and a washer 43 fitted into a groove 42 in the rotary shaft 37.

Furthermore, an optical disk 44 as a recording medium is fitted onto the turntable 40, with a clamping plate 45 being loose fitted in the center of the optical disk 44, and the clamping plate 45 is attracted toward the spindle motor 30 by the magnetic action of the clamping magnet 41 of the rotor 32.

With the above-described configuration of he conventional spindle motor 30, if the winding 35 is energized with the optical disk 44 mounted on the turntable 40, the rotor 32 is rotatively driven by the interaction between a magnetic field generated by the winding 35 and a magnetic field generated by the rotor magnet 39 and the rotor yoke 38 of the rotor 32. The optical disk 44 mounted on the turntable 40 can be rotated in synchronization with the rotation of the rotor 32 without slippage due to the attractive force of the clamping magnet 41.

However, recently, the optical disk apparatus becomes thinner and more compact, and a higher precision is demanded along with the higher density. When an attempt is made to make the conventional spindle motor thinner, a problem arises that the use of a method of either shortening the length of engagement of the plain bearing 36 and the rotary shaft 37 or shortening the length of a support member that supports the rotary shaft results in a sacrifice of precision and strength.

Furthermore, to ensure the required precision, a problem arises that the use of higher precision components becomes necessary, thereby resulting in increased costs.

### SUMMARY OF THE INVENTION

It is an object of the present invention to provide a spindle motor that has a thin rotor and a thin turntable and is therefore suitable for use in thin optical disk apparatuses.

To attain the above object, the present invention provides a spindle motor comprising a stator comprising a stationary member, a bearing member provided on the stationary member, and a winding provided on the stationary member and disposed around the bearing member, and a rotor comprising a rotary shaft rotatably supported by the bearing member, a rotary shaft support member secured to the rotary shaft, a rotary table member disposed for rotation in unison with the rotary shaft support member, the rotary table member having mounted thereon a recording medium with a clamping plate having a central hole, a yoke member disposed in opposed relation to the winding and secured to the rotary table member, and a magnet member secured to the yoke member, wherein the rotary shaft and the rotary shaft support member are inserted into the central hole in the clamping plate for the recording medium.

In a preferred form of the present invention, the rotary shaft support member and the rotary table member are secured to each other.

In this preferred form, preferably, the yoke member is indirectly secured to the rotary shaft support member.

Further, in this preferred form, preferably the rotary table member is interposed between the yoke member and the rotary shaft support member.

Preferably, the rotary table member is formed integrally with the yoke member by insert molding.

In an alternative preferred form, the rotary shaft support member and the yoke member are secured to each other.

In this preferred form, preferably the rotary table member is indirectly secured to the rotary shaft support member.

Further, in this preferred form, preferably the yoke member is interposed between the rotary table member and the rotary shaft support member.

Preferably, the yoke member is formed of a metallic ferromagnetic material.

In a typical preferred embodiment of the present invention, the recording medium provided with a clamping plate having a central hole is a recording medium selected from the group consisting of a magneto-optical recording medium, an optical recording medium, and a magnetic recording medium.

According to the present invention, a thin and inexpensive spindle motor can be obtained for use in thin optical disk apparatuses by configuring a thin rotor and a thin turntable without shortening the length of engagement of the plain bearing and the rotary shaft and without sacrificing precision and strength.

The above and other objects, features, and advantages of the invention will become more apparent from the following detailed description taken in conjunction with the accompanying drawings.

### BRIEF DESCRIPTION OF THE DRAWINGS

FIG. 1 is a schematic cross-sectional view of a spindle motor according to a first embodiment of the present invention;

FIG. 2 is a schematic cross-sectional view of a spindle motor according to a second embodiment of the present invention; and

FIG. 3 is a schematic cross-sectional view of a conventional spindle motor.

### DETAILED DESCRIPTION OF THE PREFERRED EMBODIMENTS

The present invention will now be described in detail with reference to the drawings showing embodiments thereof.

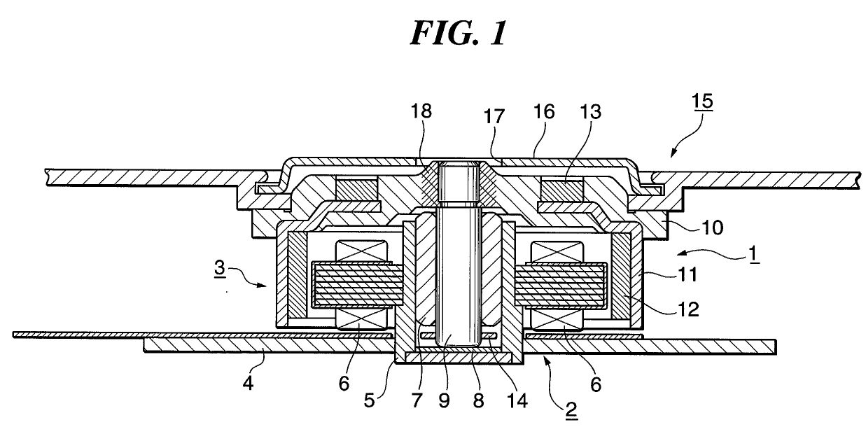

FIG. 1 is a schematic cross-sectional view of a spindle motor according to a first embodiment of the present invention.

In FIG. 1, a spindle motor 1 is comprised of a stator 2 that is fixedly mounted in an optical disk apparatus (not shown), and a rotor 3 that is supported by the stator 2 for rotation relative to the stator 2.

The stator 2 is comprised of a stator base 4, a housing 5 (stationary member) attached to the stator base 4, a plain bearing 7 (bearing member) fitted within the housing 5 by press fitting or the like, a winding 6 disposed in a fashion surrounding the housing 5 in the radial direction, and a thrust seat member 8.

The rotor 3 is comprised of a rotary shaft 9 rotatably supported by the plain bearing 7, a turntable 10 (rotary table member) having formed integrally with a rotary shaft support member 18 secured to a top end portion of the rotary shaft 9, a cylindrical rotor yoke 11 (yoke member) having an open lower end, secured to the turntable 10 and disposed in a fashion surrounding the winding 6 in the radial direction, a rotor magnet 12 (magnet member) fixedly mounted inside the rotor yoke 11, a clamping magnet 13 provided on the turntable 10, and a washer 14 secured to a lower end of the rotary shaft 9 by press fitting or the like. The rotary shaft support member 18 may be formed in one body with the turntable 10 at the same time or may be formed in a separate body and then joined to the turntable 10. The washer 14 can abut against a lower surface of the plain bearing 7 so as to prevent the rotor 3 from upwardly slipping out of the motor 1. Furthermore, the rotor 3 is attracted downward by the magnetic action of the rotor magnet 12 so that the lower end of the rotary shaft 9 is forced to be always in contact with the thrust seat member 8.

Furthermore, an optical disk 15 as a recording medium is mounted onto the turntable 10. A clamping plate 16 having a hole 17 at the center is loosely fitted in the center of the optical disk 15, and the clamping plate 16 is attracted toward the spindle motor 1 by the magnetic action of the clamping magnet 13 of the rotor 3.

With the above-described configuration of the spindle motor 1 according to the present embodiment, if the winding 6 is energized with the optical disk 15 mounted on the turntable 10, the rotor 3 is rotatively driven together with the optical disk 15 by the interaction between a magnetic field generated by the winding 6 and a magnetic field generated by the rotor yoke 11 and the rotor magnet 12 of the rotor 3.

The turntable 10 is made of a resin. The turntable 10 is formed by insertion molding together with the rotary shaft 9 and the rotor yoke 11 inserted therein. Portions of the rotary shaft 9 and the turntable 10 in engagement with each other are knurled at the periphery to increase the rotational breaking strength. The rotary shaft support member 18 is located at the center of the turntable 10 and is configured so as to be inserted together with the rotary shaft 9 into the hole 17 of the clamping plate 16 in which the optical disk 15 is fitted. Furthermore, the rotor yoke 11 is secured to the turntable 10, and a central portion of the turntable 10 is interposed between the rotor yoke 11 and the rotary shaft 9. Thus, only the turntable 10 is secured to the rotary shaft 9, and the rotor yoke 11 is not directly secured to the rotary shaft 9.

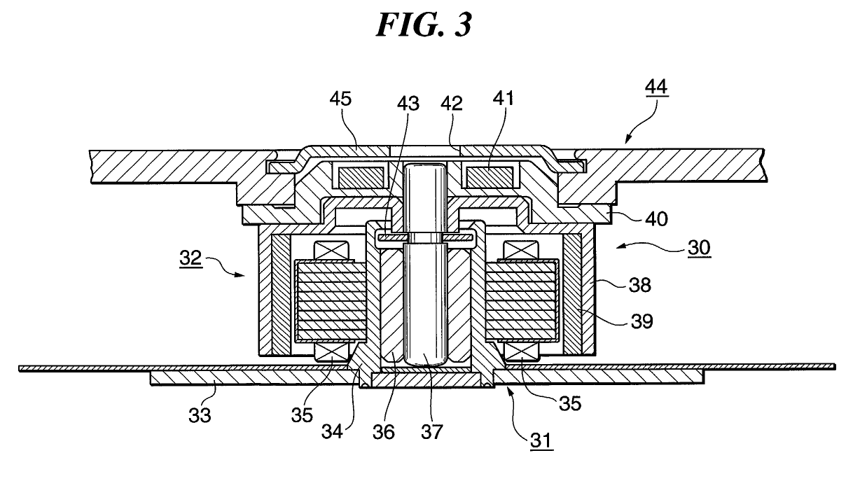

Therefore, compared to the configuration described with respect to the conventional example (FIG. 3) in which the turntable 40 and the rotor yoke 38 are secured to the rotary shaft 37, the spindle motor 1 can be made thinner. Furthermore, while making the spindle motor 1 thinner, the length of engagement of the plain bearing 7 and the rotary shaft 9 is not shortened, thereby making it possible to reduce the radial run-out (or deviation) of the rotor 3 and maintain a high precision. In addition, when forming the turntable 10, the rotary shaft support member 18 and the rotor yoke 11 are simultaneously formed together with the turntable 10 by insertion molding, whereby the spindle motor 1 can be manufactured at low costs.

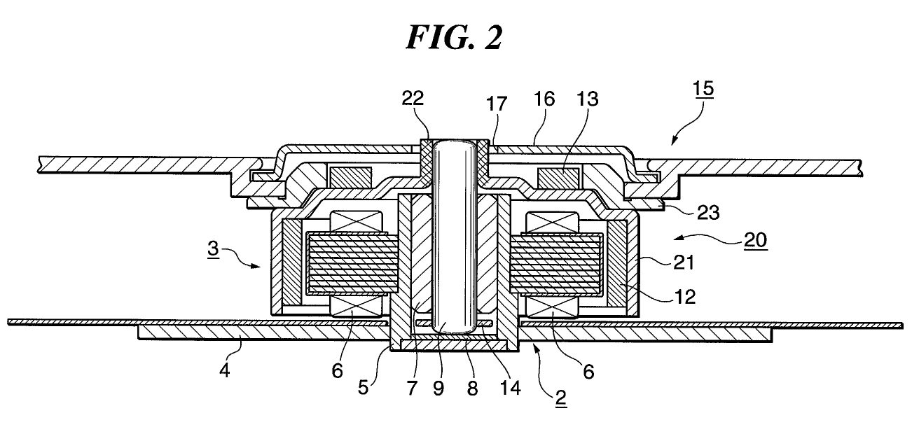

FIG. 2 is a schematic cross-sectional view of the spindle motor according to a second embodiment of the present invention. In FIG. 2, elements corresponding to those in FIG. 1 are designated by identical reference numerals. A spindle motor 20 according to the present embodiment has substantially the same entire configuration as the spindle motor 1 shown in FIG. 1.

A rotary shaft support member 22 is formed integrally, i.e. in one body with a rotor yoke 21 as a part of the rotor yoke 21, and the rotary shaft 9 is fixed fitted in and supported by the rotary shaft support member 22 of the rotor yoke 21 by press fitting or the like. That is, the rotary shaft support member 22 is formed of the same material as the rotor yoke 21, i.e. a metallic ferromagnetic material. The rotary shaft 9 and the rotary shaft support member 22 extend through the hole 17 of the clamping plate 16 and protrude upward from the top. A turntable 23 is secured to the rotor yoke 21 by bonding or the like. Furthermore, the rotary shaft support member 22 of the rotor yoke 21 is interposed between the turntable 23 and the rotary shaft 9. Thus, only the rotor yoke 21 is secured to the rotary shaft 9, and the turntable 23 is not directly secured to the rotary shaft 9.

Therefore, compared to the configuration described in the conventional example (FIG. 3) in which the turntable 40 and the rotor yoke 38 are secured to the rotary shaft 37, the spindle motor 20 can be made thinner.

According to the present embodiment, the spindle motor 20 operates in the same way as the spindle motor 1 shown in FIG. 1. However, since the rotary shaft support member 22 is a metallic ferromagnetic material, it has increased support strength with which the rotary shaft 9 is supported. Furthermore, as in the above-mentioned first embodiment, while making the spindle motor 20 thinner, the length of engagement of the plain bearing 7 and the rotary shaft 9 is not shortened, thereby making it possible to reduce the radial run-out (or deviation) of the rotor 3 and maintain a high precision. In addition, since the rotary shaft support member 22 and the rotor yoke 21 are formed in an integral body, the spindle motor 20 can be manufactured at low costs.

In the above-described first and second embodiments, the rotor yokes 11, 21 and the rotor magnet 12 provided inside the same are arranged in a fashion surrounding the winding 6 in the radial direction. However, the present invention is not limited to this configuration and may be of course applied to a configuration in which the rotor yokes 11, 21 and the rotor magnet 12 are disposed in a fashion being opposed to the winding 6 in the axial direction.

Furthermore, in the above-described first and second embodiments, the rotary shafts 9 of the spindle motors 1, 20 are provided with the means for preventing the rotor 3 from slipping out of the motors 1, 20. However, the present invention is not limited to this configuration and is also applicable to a configuration that does not require such slippage preventing means or a configuration in which such slippage preventing means is provided on a part other than the rotary shaft 9. Furthermore, the recording medium that is mounted onto the turntables 10, 23 is not limited to the optical disk 15 and may instead be a magnetic disk or a magneto-optical disk.

What is claimed is:

1. A spindle motor comprising:
a stator comprising a stationary member, a bearing member provided on said stationary member, and a winding provided on said stationary member and disposed around said bearing member; and
a rotor comprising a rotary shaft rotatably supported by said bearing member, a rotary shaft support member secured to said rotary shaft, a rotary table member disposed for rotation in unison with said rotary shaft support member, said rotary table member having mounted thereon a recording medium with a clamping plate having a central hole, a yoke member disposed in opposed relation to said winding and secured to said rotary table member, and a magnet member secured to said yoke member;
wherein said rotary shaft and said rotary shaft support member are inserted into the central hole in the clamping plate for said recording medium.

2. A spindle motor according to claim 1, wherein said rotary shaft support member and said rotary table member are secured to each other.

3. A spindle motor according to claim 1, wherein said yoke member is indirectly secured to said rotary shaft support member.

4. A spindle motor according to claim 1, wherein said rotary table member is interposed between said yoke member and said rotary shaft support member.

5. A spindle motor according to claim 1, wherein said rotary table member is formed integrally with said yoke member by insert molding.

6. A spindle motor according to claim 1, wherein said rotary shaft support member and said yoke member are secured to each other.

7. A spindle motor according to claim 1, wherein said rotary table member is indirectly secured to said rotary shaft support member.

8. A spindle motor according to claim 1, wherein said yoke member is interposed between said rotary table member and said rotary shaft support member.

9. A spindle motor according to claim 1, wherein said yoke member is formed of a metallic ferromagnetic material.

10. A spindle motor according to claim 1, wherein the recording medium provided with a clamping plate having a central hole is a recording medium selected from the group consisting of a magneto-optical recording medium, an optical recording medium, and a magnetic recording medium.
